(19) United States
(12) Patent Application Publication
(10) Pub. No.: US 2011/0190952 A1
(43) Pub. Date: Aug. 4, 2011

(54) Method and System for an Integrated Intelligent Building

(76) Inventor: Boris Goldstein, San Franscisco, CA (US)

(21) Appl. No.: 12/700,268

(22) Filed: Feb. 4, 2010

(51) Int. Cl. G06F 1/28

(52) U.S. Cl. 700/291; 700/295

(57) ABSTRACT

Described herein are systems and methods for integrated intelligent buildings, improved building security, and cost-efficient energy management. An exemplary embodiment relates to a method comprising monitoring energy usage within a facility to generate energy usage data (“EUD”), analyzing the EUD to determine a short-term energy requirement (“STER”) and a long-term energy requirement (“LTER”) of the facility, obtaining energy market data (“EMD”) of energy, the EMD including energy rate fluctuation data, and obtaining a pre-determined amount of energy from a utility provider, the pre-determined amount being determined as a function of at least one of the STER, the LTER, and the EMD.

### BACKGROUND

Energy conservation is the practice of decreasing the quantity of energy used. Conservation may be achieved through efficient energy usage, wherein energy consumption is decreased while achieving a similar outcome. Energy conservation may result in increase of financial capital, environmental value, national security, personal security, and human comfort. Individuals and organizations that are direct consumers of energy may want to conserve energy in order to reduce energy costs and promote economic security. The commercial, industrial and institutional sectors may wish to improve energy efficiency in order to lower operations costs, and thus, maximize profit.

The commercial sector consists of retail stores, offices (e.g., business and government), restaurants, schools and other workplaces. The industrial sector consists of all facilities for the production and processing of goods, such as manufacturing, construction, farming, water management, mining, etc. The institutional sector consists of schools, hospitals, prisons, etc. Approximately 15% of all electricity generated in North America is consumed by indoor lighting systems of commercial, industrial and institutional facilities. In addition, approximately another 15-20% of electricity is consumed by elevators, refrigeration systems, and high-voltage integrated circuit (“HVIC”) units.

In other words, space conditioning is the single biggest consumption area, and may represent about 30% of the energy use of commercial, industrial and institutional buildings. Certain usage, such as lighting, may be considered the most wasteful component within such buildings. Accordingly, more efficient usage of lighting, the elimination of over-illumination, and improved overall energy management can greatly reduce energy consumption within these buildings.

### SUMMARY OF THE INVENTION

Described herein are systems and methods for integrated intelligent buildings, improved building security, and cost-efficient energy management. One embodiment relates to an exemplary method comprising monitoring energy usage within a facility to generate energy usage data (“EUD”), analyzing the EUD to determine a short-term energy requirement (“STER”) and a long-term energy requirement (“LTER”) of the facility, obtaining energy market data (“EMD”) of energy, the EMD including energy rate fluctuation data, and obtaining a pre-determined amount of energy from a utility provider, the pre-determined amount being determined as a function of at least one of the STER, the LTER, and the EMD.

Another embodiment relates to an exemplary system comprising a monitoring arrangement monitoring energy usage within a facility to generate energy usage data (“EUD”), and an energy management arrangement analyzing the EUD to determine a short-term energy requirement (“STER”) and a long-term energy requirement (“LTER”) of the facility, the energy management component obtaining energy market data (“EMD”) of energy, the EMD including energy rate fluctuation data, the energy management component further obtaining a pre-determined amount of energy from a utility provider, the pre-determined amount being determined as a function of at least one of the STER, the LTER, and the EMD.

A further embodiment relates to a computer readable storage medium including a set of instructions that are executable by a processor. According to this embodiment, the set of instructions are operable to monitor energy usage within a facility to generate energy usage data (“EUD”), analyze the EUD to determine a short-term energy requirement (“STER”) and a long-term energy requirement (“LTER”) of the facility, obtain energy market data (“EMD”) of energy, the EMD including energy rate fluctuation data, and obtain a pre-determined amount of energy from a utility provider, the pre-determined amount being determined as a function of at least one of the STER, the LTER, and the EMD

### BRIEF DESCRIPTION OF THE DRAWINGS

FIG. 1 shows an exemplary system for energy management of an integrated intelligent building according to the exemplary embodiments of the present invention.

FIG. 2 shows an exemplary table for logical interrelations among objects in the integrated intelligent building according to the exemplary embodiments of the present invention.

FIG. 3 shows an exemplary system for intelligent monitoring of an integrated intelligent building according to the exemplary embodiments of the present invention.

FIG. 4 shows an exemplary system for integration of distributed video surveillance and monitoring systems according to the exemplary embodiments of the present invention.

FIG. 5 shows an exemplary method for energy management of an integrated intelligent building according to the exemplary embodiments of the present invention.

### DETAILED DESCRIPTION

The exemplary embodiments of the application may be further understood with reference to the following description and the related appended drawings, wherein like elements are provided with the same reference numerals. The exemplary embodiments of the application are related to systems and methods for integrated intelligent buildings, improved building security, and cost-efficient energy management. Specifically, the exemplary embodiments are related to systems and methods for monitoring a facility, such as an intelligent building, and managing a variety of systems, devices, components, and settings within the facility. Furthermore, the exemplary embodiments may utilize various intelligent building algorithms based on physical changes within the building, audio/video surveillance, policy management systems, detectable and scheduled events, monitored utility rates, internal and external climate changes, etc.

It should also be noted that while the exemplary embodiments of the present invention reference to an integrated intelligent building, additional embodiments of the present invention may be applied to systems and methods within any facility, structure or location, such as, for example, a warehouse, a office complex, a campus, an area including a collection of multiple buildings, an intelligent building, etc.

According to the exemplary embodiments of the present invention, a building may be integrated with an intelligent management system in order to efficiently manage power consumption. Therefore, his intelligent management system may save a significant portion of energy in an economically feasible manner. In addition, analysis of weather/climate information and utility rates (e.g., peak/off-peak prices for electricity) may allow for additional savings. For instance, during off-peak hours, the building may selectively draw electricity from a power grid. During peak hours, the building may draw electricity from alternative sources, such as solar and wind systems, and utility storing system (e.g., power cell, an energy bank, etc.) within the building.

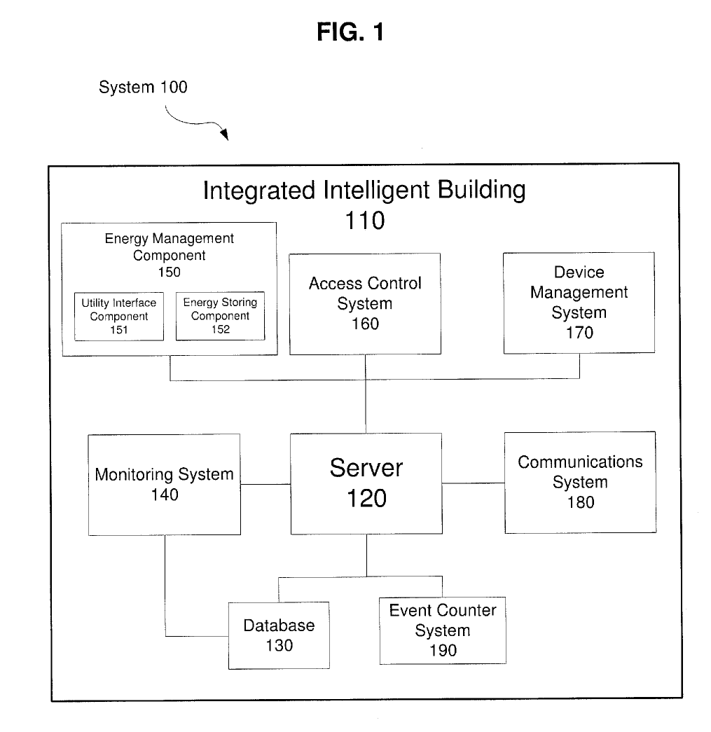

FIG. 1 shows an exemplary system 100 for energy management of an integrated intelligent building 110 according to the exemplary embodiments of the present invention. The system may include the integrated intelligent building 110 as well as a server 120 for consolidating and processing any data received from various components of the system 100. These various arrangements or components of the system may include a database 130, a monitoring system 140, energy management component 150, an access control system 160, a device management system 170, a communications system 180, and an event counter system 190. Each of these components will be described in greater detail below. It should be noted that the terms “arrangement” and “component” may be used interchangeably.

It should be noted that the exemplary system 100 is not limited to a particular set of included components, and may include any number of components, either more or less than those illustrated in FIG. 1. Furthermore, each of these components of the system 100 may reside on a single component, or alternatively, on any number of components within the system 100. It should also be noted that while FIG. 1 displays a single building, integrated intelligent building 110, exemplary embodiments of the present invention may be applied to a system having any number of buildings, such as, for example, a office complex, a campus, or any area including a collection of multiple buildings.

As will be described in greater detail, the server 120, in coordination with the energy management component 150, may perform a set of exemplary functions related to monitoring and maintaining the intelligent building 110. Specifically, the server 120 and the energy management component 150 may be responsible for controlling the receipt, delivery, use, distribution, and release of energy throughout the intelligent building 110. According to the exemplary embodiments of the system 100, the energy management component 150 may receive monitoring data from the monitoring system 140 and receives climate data from a climate observation system within the intelligent building 110. The energy usage of the intelligent building may be monitored in order for the energy management component 150 to generate energy usage data (“EUD”). The EUD may then be analyzing to determine a short-term energy requirement (“STER”) and a long-term energy requirement (“LTER”) for the building 110.

Furthermore, the energy management component 150 may include a utility interface component 151 for obtaining energy from a utility provider for immediate use (e.g., short-time use) and for future use (e.g., long-time use) within the intelligent building 110, an energy storing component 152 for storing energy for future use in a storage system. For instance, the utility interface component 151 may be in communication with a utility provider, such as an entity for delivering electricity to the building 110. It should be noted that the energy management component 150 may thus provide energy to the intelligent building 110 from the storage system. In addition to stored energy, the energy management component may also provide energy to the intelligent building 110 directly from the utility provider.

In addition to managing energy usage, the energy management component 150 may further receive utility pricing-rate information, or energy market data (“EMD”), for energy provided to the building 110 from the utility provider. Specifically, the energy management component 150 may receive and track the price of electricity provided by the utility provider. The tracking of the price may be performed during a pre-determined internal of time (e.g., hourly, daily, weekly, monthly, etc.). For instance, the price of electricity may be more expensive during peak-usage time periods (e.g., during regular business hours, such as from 9:00 AM to 5:00 PM).

The energy management component 150 may track and report this utility rate data. Furthermore, the energy management component 150 may then adjust the energy usage throughout the intelligent building 110. During off-peak hours (e.g., non-business hours), electricity from the utility provider may be less expensive. Accordingly, the energy management component 150 may store energy provided by the utility provider for future use into the storage system. During peak hours (e.g., business hours), electricity from the utility provider may be more expensive. Accordingly, the energy management component 150 may use the stored energy instead of (or in addition to) energy received directly from the utility provider. Thus, the energy management component 150 may adjust a pre-determined amount of stored energy for future use (e.g., LTER) based on the monitoring data, the climate data, and the utility pricing-rate data.

According to the exemplary embodiments of the present invention, the server 120 may allow for compatibility between the system 100 and the various components. Specifically, the server 120 of the system 100 may include a plurality of integrated intelligent building operations. Operations may include the analysis of utility prices (e.g., electricity rates), the adjusting the storage of utility resources (e.g., retaining electricity in a system for storing power), and the activation of alternative energy sources (wind, solar, etc.). Thus, these operations may employ algorithms designed for the deployment of an industrial scalable, flexible (e.g., adjustable) integrated security and energy-saving systems. As will be described in greater detail below, the operations of the server 120 may be based on data received from the various components of the system 100 and the algorithms stored within the database 130.

The operations of the server 120 may include integration of digital video received from the monitoring system 140 with existing data provided by various security equipment, supervisory control and data acquisition (“SCADA”) systems, as well as the energy management component 150. The server 120 may provide single-source registration and processing of events, such as scheduled events (e.g., hours of business operations) and emergency events (e.g., fire/security alarms). The server 120 may exchange data with the communications system 180 in order to generate notifications.

Ultimately, the capabilities of the system 100 and the server 120 are limitless. The operations of the server 120 may be fully scalable to match any desired solution for the intelligent building 110. For instance, the server 120 may make specific adjustments in the re-distribution of available resources, change the number and/or quality of tasks being monitored, and adjust the operation of various devices, systems, equipment, etc.

The integrated intelligent building algorithm software, server configuration parameters, and any remote admin workstations configuration parameters may be stored in the distributed database 130. Accordingly, each server and remote admin workstation may store local copies of this distributed database 130. The local database copies may then be synchronized in order to provide uniform distributed operation of integrated intelligent building algorithm software and data replication (e.g., synchronize any alterations of local database copies). Accordingly, the synchronization of servers and remote admin workstations may comply with the video surveillance system project design.

The database 130 may further be utilized for integrated intelligent building algorithm software data management. Specifically, integrated intelligent building algorithm software data of the database 130 may provide data storage, such as data related to registered system objects and their settings, departments and user accounts and rights, on registered system events, changes in servers and Remote Admin Workstations configuration, changes in registered system object specifications and their settings, network names and IP addresses of distributed system servers, remote admin workstations, remote monitoring workstations and their interaction parameters, etc. The database 130 may also provide for data replication from different servers and remote admin workstations.

According to the exemplary embodiments of the present invention, when the integrated intelligent building algorithm software is applied by a large-scale system with distributed architecture, the servers and remote admin workstations databases may be synchronized. Database synchronization may allow for storage of data both centrally (e.g., on a single server or remote admin workstation), as well as in a distributed manner (e.g., data replication from different servers and remote admin workstation databases of the video surveillance system). In addition, database synchronization may provide parallel operation with servers and remote admin workstations databases by automatically updating database after other databases have been modified. It should be noted that the integrated intelligent building algorithm software databases on servers and Remote Admin Workstations may not be synchronized by default. For instance, the integrated intelligent building algorithm software may be configured to synchronize all databases with a single centralized administering server database.

The monitoring system 140 may provide the integrated intelligent building algorithm software with surveillance data. For instance, the integrated intelligent building algorithm software may analyze video image brightness and contrast adjustment in the different modes, depending on the demands of the video characteristics. In one mode, brightness may be adjusted for auto brightness and contrast adjustment. In this mode, the integrated intelligent building algorithm software may automatically apply the internal algorithm of video image brightness and contrast adjustment. Also, in auto-mode, manual brightness and contrast adjustment may be unavailable. The auto-mode may be default-activated and may not require any additional settings. This mode for automatic adjustments of brightness and contrast may be recommended for video image with no special demands on video characteristics.

According to an alternative more, brightness and contrast may be adjusted manually. In this manual mode, the administrator may change image brightness and contrast settings. In a further mode, manual brightness and contrast adjustments may be performed with automatic optimization. In this optimization mode, the administrator may manually preset values for “Brightness” and “Contrast”. Once the preset values are confirmed, the integrated intelligent building algorithm software may automatically launch the process of video image brightness and contrast optimization.

The integrated intelligent building algorithm software may utilize a “motion wavelet” algorithm in order to process and compress the video and data signal received from the monitoring system 140. Specifically, video signals processed by this algorithm may be sequenced in “keyframes” and “delta frames”. A keyframe may be defined as the full frame of the video image, while a delta frame (e.g., differential frame) may be defined as the video image frame that contains only the pixel blocks that differ from the previous keyframe. In order to compare the pixel block of the keyframe to that of the frame next to the keyframe, the average brightness of these blocks may be compared. Accordingly, if the difference in brightness exceeds a preset value, the block may then be considered to have fixed motion, and thus, it becomes part of the delta frame. Otherwise, the block is considered to have no motion, and it is not included into the delta frame.

Accepted values of pixel block brightness may lie within a predetermined range, such as 0-225 units of brightness. The block may become part of the delta frame by default if the difference between its average brightness in the current frame and in the previous keyframe exceeds a preset value, such as 7 units. If this value is increased, the size of the delta frame may be reduced, and the video stream size is consequently decreased due to the fact the delta frame now contains less pixel blocks.

The optimal value of the parameter for setting the criterion for blocks to be entered into the delta frame may be defined by the brightness gradient of the video image background and the moving objects in the frame. Accordingly, the parameter may be increased with a high gradient. Alternatively, the parameter value may be decreased with a low gradient.

The monitoring system 140 may implement several types of motion detectors. Motion detectors may provide automatic video image analysis to recognize events occurring within an observed scene. Accordingly, event recognition capabilities may depend on the detector type. In integrated intelligent building algorithm software, the various types of detectors may include, main motion detector, subsystem motion detector, focusing detector, video signal stability detector, background change detector, camera blinding detector, camera covering detector, lost items detector, object tracking detector, infrared detector, etc. According to one embodiment, the integrated intelligent building algorithm software may primarily use the main motion detector for detecting the video surveillance camera alarms. The other detectors may then be optionally activated in the course of integrated intelligent building algorithm software administration.

The communication facilities, such as the communication system 180, of integrated intelligent building algorithm software may allow for deployment of distributed digital systems for controlling lengthy and versatile objects. Each of the remote system components may interact automatically with one other, thereby forming a common security and energy saving system. Data exchange and communication between distributed digital video surveillance and energy savings monitoring system may be supported by local access networks (“LANs”), Internet, wide area networks (“WANs”), telephone lines (e.g., Dial-Up), leased communication channels, etc. Accordingly, the communications facilities may utilize the transmission control protocol/internet protocol (“TCP/IP”) telecommunications transportation protocol.

The communication system 180 may allow for notifications to be transmitted via various communications channels. For instance, short message service (SMS) may be used for sending short messages to mobile phones about alarm events registered by integrated intelligent building algorithm software. A short message may also be sent automatically upon registration of any of the events specified in the corresponding macro. The short messages may be transferred using the services of the GSM mobile providers, such as GSM modems, GSM adapters, mobile phones, etc.

A mail message service (e.g., email) may be used for sending e-mail messages to remote system users about the alarm events registered by integrated intelligent building algorithm software. Sending e-mail messages may be triggered automatically upon registration of any of the events set in the macro. In order to send e-mail messages, the communication system 180 may be connected to the Internet via a local area network or remote TCP/IP connection. Accordingly, the e-mail messages may be sent by the mail message service. To send e-mail messages in integrated intelligent building algorithm, the communication system 180 may first register a mailbox in the mail message service.

A voice message service may also be used to transmit voice messages over telephone lines. This service may automatically dial specified phone numbers and transmit pre-recorded audio files. Various dialing options may include “until connection”, “until answer”, “until digital acknowledgement of message reception”, etc. In order to a voice message, the communication system 180 may include a voice modem (V-Dial) component.

The event counter system 190 may be designed for counting the specified types of events on the specified objects. This system may not a hardware component and may fulfil auxiliary functions in programming the integrated intelligent building algorithm system. The event counter system 190 may not have a separate interface window for data input/output, and thus, may most commonly used together with other system components. The counter may notify the system 100 about the collected statistical data using a “Data Collected (SIGNAL_POINT)” message. Various notification modes may include a mode for a specified period of time and a mode for a specified number of events. In the first mode, a notification may be issued upon expiration of a set time period after the start of counting. In the second mode, a notification may be issued when a certain amount of events has been counted. An option for conditional count reset may also be available. Furthermore, reset modes may be available, such as a reset mode for a specified period of time and a reset mode for a specified number of events. In the first reset mode, the counter may be reset upon expiration of a set time period after the start of counting. In the second reset mode, the counter may reset when a certain amount of events has been counted.

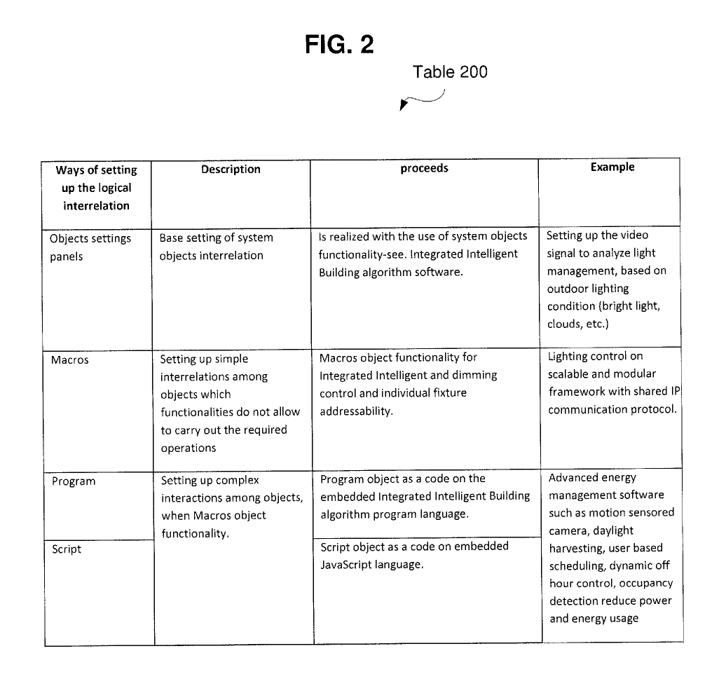

FIG. 2 shows an exemplary table 200 for logical interrelations among objects in the integrated intelligent building 110 according to the exemplary embodiments of the present invention. Specifically, the functional facilities of algorithm software for the intelligent building 110 may be based on local cooperation of various objects. The table 200 may illustrate one exemplary manner of setting up these logical interrelations, including descriptions, processes, and examples for each of the logical interrelations.

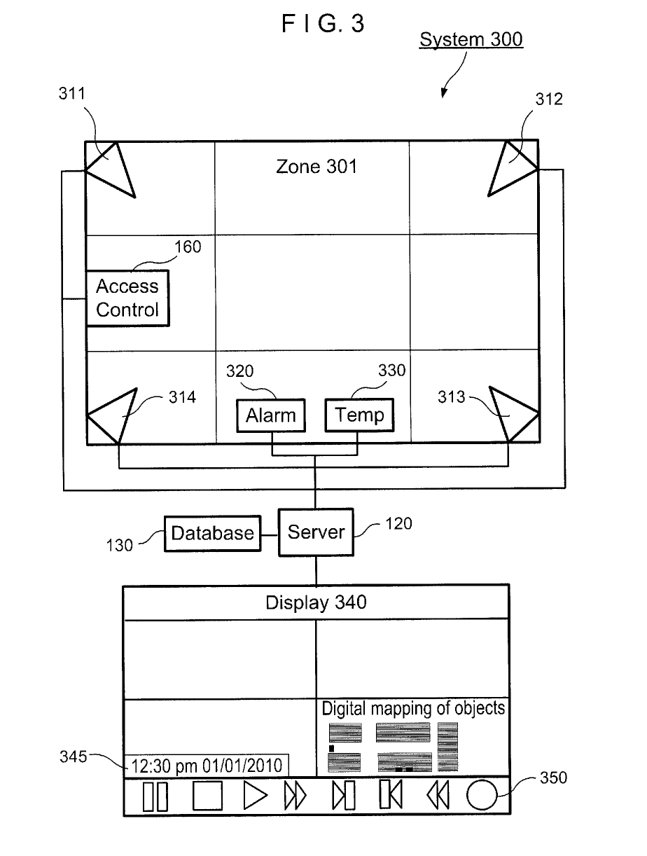

FIG. 3 shows an exemplary system 300 for intelligent monitoring of an integrated intelligent building 110 according to the exemplary embodiments of the present invention. The system 300 will be discussed with reference to the intelligent building 110 and other components of the system 100 of FIG. 1. It should be noted that system 300 may be an exemplary embodiment of the monitoring system 140 within the building 110.

The system 300 may be implemented in any number of locations within the building 110. For instance, the system 300 may monitor an exemplary zone 301 (e.g., a floor) of the building 110. While FIG. 3 provides an illustration of a single location within the building 110, this concept may be applied to any number of locations within the building 110, and/or any number of buildings within a complex. Thus, the single zone view of FIG. 3 is merely for illustrative purposes.

The system 300 may include multiple devices for monitoring the zone 301 and providing the server 120 with intelligent surveillance data. Multiple video cameras 311-314 may be deployed throughout the zone 301, as well as any number of security alarms 320 (e.g., fire alarms, smoke detectors, etc.). The system 300 may further include a climate sensor 330, such as a temperature sensor, a thermostat, etc. The system 300 may also include the access control system 160 (e.g., a numeric keypad, an RFID card reader, etc.) for entry onto the zone 310. These various devices may detect and report surveillance data to the server 120 for processing. As will be noted below, this surveillance data may also be stored within the database 130 for achieving and record keeping.

The surveillance data processed by the server 120 and stored in the database 130 may be displayed to a user (e.g., n operator, a network administrator, etc.) via a display 340. The display 340 may be provided to the user though a computing device, such as a centralized workstation, a mainframe, a desktop computer, a portable computer, a handheld device, etc. It should be noted that the display 340 and the server 120 may be integrated into a single computing device. Alternatively, the display 340 and the server 120 may components within two separate devices.

The exemplary display 340 may provide the user with multiple simultaneous views (e.g., flexible split-screen configurations) of video surveillance data received from the multiple video cameras 311-314. In addition, the display 340 may provide the user with visual indicators of the status for any number of alarms and other security features. Accordingly, the display 340 may provide priority-oriented automatic selection of security and energy efficiency system. For instance, the display 340 may illustrate the status of the fire alarm 320, the temperature sensors 330, the status of the access control system 160, etc. Therefore, the display 340 may allow for priority-oriented event management of critical energy and security stream based on alarm detection.

Depending on any set of parameters, the display 340 may select specific status alerts and/or images for the user's viewing. The display 340 may allow various additional viewing options, such as, for example, priority window magnification (e.g., surveillance video window), magnified surveillance slideshow for a specific video camera, event driven status alerts (e.g., sensor readings, temperature readings, time schedule, building occupancy, etc.). The display 340 may provide digital mapping of the monitoring devices within the zone 301, such as digital representations of the multiple video cameras 311-314, the security alarms 320, the climate sensor 330, the access control system 160, etc. The display 340 may provide digital mapping data of other objects throughout the zone 301, such as lights, elevators, escalators, refrigeration units, climate control systems (e.g., air condition units, heating units, etc.), HVICs, etc. The display 340 may include real-time viewing of images in various configurations, and may allow for digital layering of the mapping data over the recorded surveillance data. Furthermore, the display 340 may also include a timestamp 345 for archiving purposes.

According to the exemplary embodiments of the display 340, an interactive map of the integrated intelligent building algorithm system may use graphical diagrams of a guarded territory in order to navigate among the surveillance system components. This interactive map may allow for controlling various objects from the context menus of the graphical symbols on the map showing the states of the corresponding objects. The interactive map may also be comprised of a set of plans (e.g., in layers) made of photographs, maps, diagrams, drawings in .BMP format, etc. The integrated intelligent building algorithm system may allow for composing a “map object” of several graphical plans of the guarded area. For instance, each of the graphical plans may be represented by a “layer object”. In addition, the integrated intelligent building algorithm system may allow for creating multilevel maps comprised of several layers. In the case of a multiple-layer map, links may be established between the layers, wherein these links may help move to other layers for operative control and viewing of the device objects located on them.

As noted above, the database 130 may store the surveillance data from the monitoring devices (e.g., video recordings from the video cameras 311-314, etc.) for audio and video archive management. For instance, the database 130 may allow for event recording, such as, but not limited to, continuous recording, scheduled recordings, recording upon alarm (e.g., fire alarm may trigger an event recording), user-initiated recording (e.g., quality assurance, system evaluation, training exercises, etc.). The database 130 may provide the user with a search archive of recorded events having search and retrieve options (e.g., timestamp, date, event type, camera identification, etc.).

The surveillance data provided to the display 340 may also be managed by user-initiated “on-demand” controls 350. Theses controls 350 may allow the user to activate recording, rewind data, fast-forward data, freeze-frame images without interrupting a recording event, adjusting video settings, adjust image processing, etc. Image processing options may include digital zooming, contrast maximizing, image sharpening, masking, dynamic outlining, etc. The database 130 may allow for synchronized playback of recorded data (e.g., surveillance footage) received from the multiple cameras 311-314.

The display 340 may allow for integrated use of various types of multi-zone detectors. These detectors may include main motion detectors, sub-system motion detectors, focus loss detectors, video signal stability detectors, changes in the image background, light-stuck camera lens, closing camera lens, abandoned items, object trackers, infrared detectors, etc. The display 340 may allow for detector zone masking, as well as image de-interlacing.

It should be noted that access to the database 130 may be performed locally at the display 340, or alternatively, remotely via another device. In other words, the system 100 may allow for remote access to the database 130 from any workplace through having both a local and a remote archive recording option. Access to the surveillance data on the database 130 may also be achieved via a web-based interface, securely accessible to any device having access to the Internet. Therefore, surveillance data and/or events may be viewable from any system workplace using a TCP/IP communications environment of the communications system 180.

The communications system 180 may further include various notification functionalities. For example, the communications system 180 may provide the user and the system 100 with automatic notifications using short message service (“SMS”) messages, email notifications, voice-dial auto-dialing services, audible/voice notifications, etc. Therefore, the communications system 180 may alert the user of any events taking place within the system 100. The communications system 180 may automatic provide the user with a display of the zone, floor, or building experiencing the event. This automatic display may take place locally at the display 340, or remotely via a web-based portal.

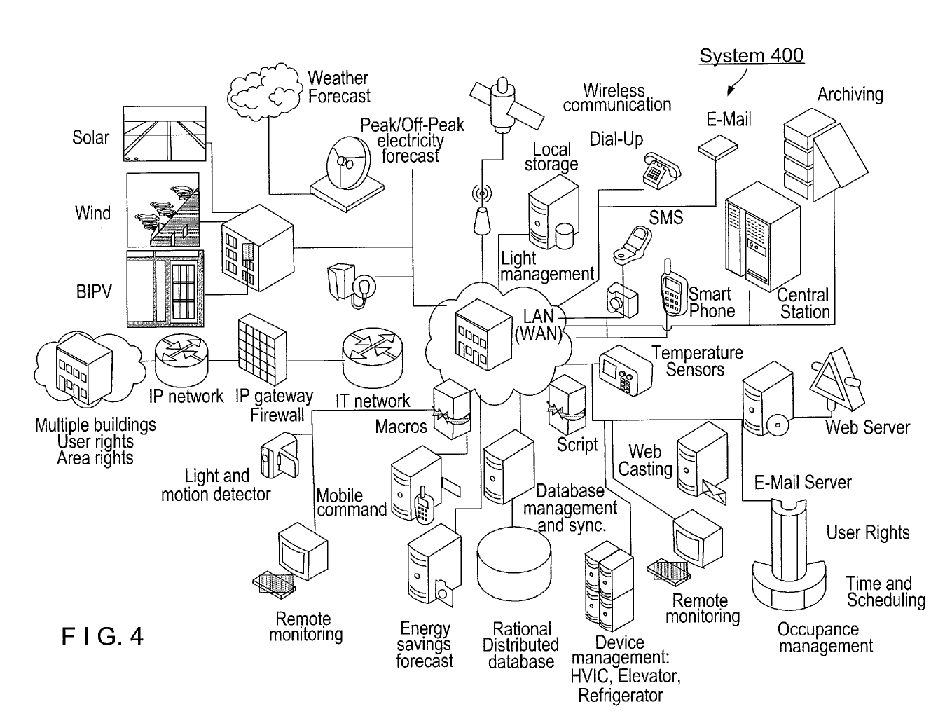

FIG. 4 shows an exemplary system 400 for integration of distributed video surveillance and monitoring systems according to the exemplary embodiments of the present invention.

According to the exemplary embodiments of the present invention, the system 400 may allow for remote interaction of the program kernel and automated replication of internal databases, such as database 130. These internal databases may contain system setup parameters and data about the events registered by the system. The interaction between servers, such as server 120, and an administrator automated workstation, may include the distributed digital video surveillance and energy efficient system information.

The system 400 may allow for the generation of the integrated database of system setup parameters and registered events, followed by data processing in compliance with standard and specialized adjustable algorithms. This may also include the generation of notifications and system response via the communications system 180. In addition, the system 400 may allow for programmable optimization of data flows within the distributed digital video surveillance system. For instance, this may be applied whenever throughput capacity of the communication links is not sufficient (e.g., optional gateway function).

The exemplary server 120 may include software kernels, program modules, and an internal server database. Specifically, a full-featured integrated intelligent building algorithm software kernel may ensure operation the server 120 and various workstations (e.g., administrator and operator workstations). It should be noted that this option corresponds to an integrated intelligent building software module. Software kernel may also include minimized functionality in order to support remote operator workstation (“ROW”) functions. Software of a remote operator workstation may not support system administration functions such as creating, deleting, setting system objects, registering users and user rights administration, or local database maintenance. Operations with ROW may use a remote database operated by the integrated intelligent building kernel, wherein the operations may belong to the server 120 or a remote administrator workstation.

According to the exemplary embodiments of the present invention, the full-featured integrated intelligent building algorithm software kernel may be the central software component of the system 400. The system kernel may interact with the various program modules, which may then form the software basis for any number of subsystems within the system 499. The integration of the distributed digital video surveillance and energy savings monitoring system may thus be provided by the data exchange between software kernels.

The program modules may support direct inter-working of the hardware within the system 400. In addition, the program modules may also serve as a source of data about controllable objects. The software kernel of the system 400 may process the incoming data from various program modules in order to provide their integration. The list of the program modules available for the operations may depend on the configuration options of the system 400. For instance, executive files corresponding to the subsystems may be automatically launched by the kernel as the system 400 is configured.

The internal server database 130 may include information such as system settings (e.g., objects created in the system, object attributes, users and user rights, etc.) and event logs (e.g., events registered by the system 400 within a period as defined at the system configuration stage). Information about the objects, event logs, settings of the digital surveillance and energy savings monitoring system may be automatically replicated from the server database (or remote administrator workstation) to the databases of all other servers and remote administrator workstations of the system 400. As noted above, communication between full-featured program kernels of the Integrated Intelligent Building algorithm system may be supported by the TCP/IP environment.

Information about system objects and their settings may be initially stored in the database of the server (or remote administrator workstation). Accordingly, replication may be automatically initiated whenever data is changed or the kernel is launched or communication is restored. Furthermore, replication may be used to create a common event environment within the distributed building integrated system 400.

The digital surveillance and energy savings monitoring system based on integrated intelligent building algorithm software may be comprised of multiple workstations, such as a remote operator workstation, a remote administrator workstation, a video server supporting operator and administrator workstation functionality, etc. The “remote monitoring workstation” option may be selected at the installation of the integrated intelligent building algorithm software on a computer system (e.g., a PC). It should be noted that PCs may be designed to function as Operator Workstations and may not be furnished with specialized hardware for the energy management system and video input. PCs with the administrator workstation software installed may process incoming sensors and video signals from IP-units (e.g., server functionality).

According to the exemplary embodiments of the present invention, basic modules may interact with the integrated intelligent building algorithm kernel via a data exchange interface of the algorithm kernel. Specifically, basic models may interact using a dynamic library. Integrated intelligent building algorithm object may contain information about integrated modules (e.g., objects) required to support operation of the algorithm kernel. Accordingly, at the object integration stage, the names, values, and parameters of the integrated object, as well as any related system events and responses used for this object, may be recorded in the system setting files. Consequently, basic module may support two-way data exchange between the integrated intelligent building algorithm kernel and module. In order to simplify integration with the joint data systems, auxiliary software and/or extension modules, the integrated intelligent building algorithm may provide an alternative interface for data exchange between modules and the algorithm kernel.

The integrated intelligent building algorithm software architecture may be designed for “inter-task” communication between the integrated intelligent building algorithm kernel and the modules (e.g., joint information systems) using the TCP/IP communication environment. Specifically, parameters such as port number, IP address of the PC using the algorithm kernel, an identifier of the connectable object, etc. may be utilized in order to support communication. Accordingly, interface object may be created in an integrated intelligent building algorithm software tree based on the PC object at the stage of integrated intelligent building algorithm software configuration.

In order to enable inter-working between modules and the integrated intelligent building algorithm kernel, one or more prerequisites may be complied with. For instance integrated software may be adjusted for TCP/IP data exchange in the integrated intelligent building algorithm kernel format. Alternatively, an interface program module may be developed to support transmission of events and responses of the integrated software in the integrated intelligent building algorithm kernel format and interoperate with the kernel through TCP/IP. It should be noted that this option may be used in cases where integrity of the integrated software is especially important (e.g., integration of HVIC, refrigerator, elevator data management software, etc).

Being a module and hierarchy object-based structure, integrated intelligent building algorithm software may ensure efficient extension of functionalities through the integration of modules supporting new equipment or new service functions.

While designing the distributed intelligent integrated building system structure, an administrator should take into account the number of servers, remote admin workstations and remote monitoring workstations to be installed on the guarded location. Furthermore, the administrator should take into account the distances between system components, as well as their communication channels capacity. For example, servers may be divided by long stretches of land, while the remote admin workstation and remote monitoring workstation may reside within the same room (e.g., a central station). Given the engineering constraints, servers may have the low capacity channels, and the remote admin workstation and remote monitoring workstation will have high capacity channels. Then remote admin workstation and remote monitoring workstation may interact with the servers via the gateway only. In addition, the administrator should also take into account the system security requirements. For example, in order to prevent unauthorized administering, subnets with servers and remote admin workstations and subnets with remote monitoring workstations may be separated. Accordingly, subnets may be limited to interact via the gateway only.

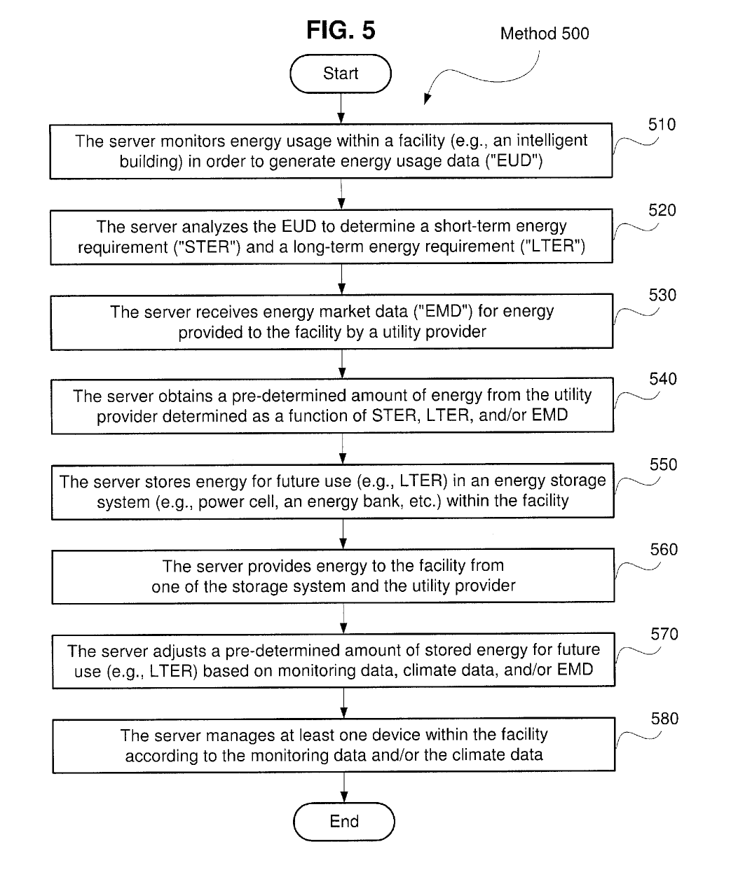

FIG. 5 shows an exemplary method 500 for intelligent monitoring of an integrated intelligent building 110 according to the exemplary embodiments of the present invention. The method 500 will be discussed with reference to intelligent building 110 and components of the system 100 of FIG. 1. It should be noted that method 500 is merely an exemplary embodiment of the steps and processes performed by the intelligent building 110. Accordingly, any number of steps within the method 500 may be repeated or omitted or performed in any sequence. In other words, the methods performable by the intelligent building 110 are not limited to the number steps illustrated in FIG. 5, nor the order/arrangement of the steps illustrated in FIG. 5. Furthermore, it should be noted that the step described below may be stored on a computer readable storage medium, wherein the steps (or set of instructions) may be executable by a processor. For example, the steps may be executable via a single web interface available to a user.

Beginning with step 510, the server 120 may monitor energy usage within a facility, such as the intelligent building 110, in order to generate energy usage data (“EUD”). According to the exemplary embodiments of the method 500, monitoring energy usage may include receiving monitoring data from a monitoring system within the intelligent building 110, as well as receiving climate data from a climate observation system within the intelligent building 110. The monitoring data may include audio surveillance data and video surveillance data. Furthermore, the climate data includes at least one of external weather condition data and internal climate control data.

In step 520, the server 120 may analyzing the EUD to determine a short-term energy requirement (“STER”) and a long-term energy requirement (“LTER”) of the intelligent building 110.

In step 530, the server 120 may receive energy market data (“EMD”), such as utility pricing-rate information, for energy provided to the intelligent building 110 by a utility provider. For instance, the EMD may include energy rate fluctuation data.

In step 540, the server 120 may obtain a pre-determined amount of energy from the utility provider. For instance, this pre-determined amount may be determined as a function of any one of the STER, the LTER, and/or the EMD.

In step 550, the server 120 may store energy for future use (e.g., LTER) in a utility storage system (e.g., power cell, an energy bank, etc.) within the intelligent building 110.

In step 560, the server 120 may provide energy to the intelligent building 110 from one of the storage system and the utility provider.

In step 570, the server 120 may adjust a pre-determined amount of stored energy for future use (e.g., LTER) based on factors such as the monitoring data, the climate data, and/or utility pricing data (e.g., EMD).

In step 580, the server 120 may manage at least one device within the intelligent building 110 according to the monitoring data and/or the climate data. As described above, the devices may be managed by the device management system 170. The devices may include lighting systems, refrigeration units, climate control systems, elevators, escalators, and high-voltage integrated circuit (“HVIC”) units.

According to an alternative embodiment, or an additional embodiment of the exemplary method 500, the server 120 may also release excess energy stored for future use. For example, the released excess energy may be made available for sale to an entity external to the intelligent building 110.

According to the various embodiments of the present invention, the integrated intelligent building algorithm software system may support signals reception, data digitization, processing and playback using video capture IP-devices. In other words, IP-cameras and IP-servers may be used to receive and process video signals. These exemplary IP-devices may be configured via a web-server module or any other software supplied together with the device, also well as via the integrated intelligent building algorithm software. Video signal compression and processing settings (e.g., format, frame rate, frame resolution, brightness, contrast, color depth, color rendition format, etc.) may then be performed via the web-server or any other software supplied together with the device. The integrated intelligent building algorithm software system may receive the image data, process the image data with detectors, recording video signals from IP-devices, and then transfer the signals to the remote monitoring workplace.

Before using an IP-device, the administrator may confirm that the processing and digitization settings of IP-devices (e.g., codecs, etc.), set via the web-server, are supported by integrated intelligent building algorithm software. Accordingly, the administrator may be provided with a list of integrated intelligent building algorithm software compatible IP-devices for video signal reception, digitization, processing.

The Web-server module, or web-server, may be used for viewing the information in a web browser using the TCP/IP communication protocol. The Web-server may provides some of the functions of an HTTP server, data transfer gate, and HTTP control commands. For instances, the web-server may provide HTTP server functionality, such as access control through authorization, operating as a gate for transferring data using HTTP protocol, video monitoring and camera control through the web browser using the TCP/IP environment, control of camera movement through the web browser using the TCP/IP environment, viewing the archives stored on the server for each device through the window, limiting access rights for viewing the video feed from the cameras, controlling devices and sensors, and viewing recordings from the server, displaying the video signal parameters (e.g., frame rate per second (“FPS”), frame size (in kB)) in the surveillance window, etc. Additionally, the Web-server may act as a mobile-server, providing capabilities through various computing devices (e.g., PocketPCs, smartphones, PDAs, etc.).

The integrated intelligent building algorithm software may be set up to require user authorization upon entering the Web-server. Access to viewing and controlling the movement of the cameras of the monitoring system 140 through the Web-server may be defined by the module settings. The web-server operation may utilize network traffic. According to one embodiment, the web-server may estimate the network traffic in order to efficiently manage costs associated with network use. For instance, the volume of network traffic when using the Web-server may depend on a number of factors, such as the number of cameras displayed on the surveillance monitor, the compression level of the video signal, the frame size (e.g., kB) of the video signal, frame rate (“FPS”) of the video signal, etc. Furthermore, the traffic volume may be monitored on the Web-server via surveillance windows. When set up, the current frame size and frame rate for each camera may be shown in the surveillance windows. The traffic may be approximately estimated by the following formula: Traffic={Viewing time}*{Number of cameras}*{Average frame size}*{Average frame rate}.

It will be apparent to those skilled in the art that various modifications may be made in the described embodiments, without departing from the spirit or the scope of the application. Thus, it is intended that the present disclosure covers modifications and variations of this application provided they come within the scope of the appended claimed and their equivalents.

It is claimed:

1. A method, comprising:
monitoring energy usage within a facility to generate energy usage data (“EUD”);
analyzing the EUD to determine a short-term energy requirement (“STER”) and a long-term energy requirement (“LTER”) of the facility;
obtaining energy market data (“EMD”) of energy, the EMD including energy rate fluctuation data; and
obtaining a pre-determined amount of energy from a utility provider, the pre-determined amount being determined as a function of at least one of the STER, the LTER, and the EMD.

2. The method of claim 1, further comprising:
storing energy for the LTER in a storage system; and
providing energy to the facility from one of the storage system and the utility provider.

3. The method of claim 1, wherein the monitoring energy usage includes receiving surveillance data from a monitoring system within the facility, the surveillance data includes at least one of audio surveillance data and video surveillance data, and the EUD is generated as a function of the surveillance data.

4. The method of claim 1, wherein the monitoring energy usage includes receiving climate data from a climate observation system within the facility, and the EUD is generated as a function of the climate data.

5. The method of claim 4, wherein the climate data includes at least one of external weather condition data and internal climate control data.

6. The method of claim 1, further comprising:
adjusting the pre-determined amount of energy for the LTER based on at least one of surveillance data and climate data.

7. The method of claim 1, further comprising:
managing, by a device manager, at least one device within the facility according to at least one of surveillance data and climate data.

8. The method of claim 9, wherein the at least one managed device includes lighting systems, refrigeration units, climate control systems, elevators, escalators, and high-voltage integrated circuit (“HVIC”) units.

9. A system, comprising:
a monitoring arrangement monitoring energy usage within a facility to generate energy usage data (“EUD”); and
an energy management arrangement analyzing the EUD to determine a short-term energy requirement (“STER”) and a long-term energy requirement (“LTER”) of the facility, the energy management component obtaining energy market data (“EMD”) of energy, the EMD including energy rate fluctuation data, the energy management component further obtaining a pre-determined amount of energy from a utility provider, the pre-determined amount being determined as a function of at least one of the STER, the LTER, and the EMD.

10. The system of claim 9, further comprising:
an energy storing arrangement storing energy for the LTER in a storage system; and
a utility interface arrangement providing energy to the facility from one of the storage system and the utility provider.

11. The system of claim 9, wherein the energy management component receives surveillance data from a monitoring system within the facility, the surveillance data includes at least one of audio surveillance data and video surveillance data, and the EUD is generated as a function of the surveillance data.

12. The system of claim 9, wherein the energy management component receives climate data from a climate observation system within the facility, and the EUD is generated as a function of the climate data

13. The system of claim 12, wherein the climate data includes at least one of external weather condition data and internal climate control data.

14. The system of claim 9, wherein the energy management component adjusts the pre-determined amount of energy for the LTER based on surveillance data and climate data.

15. The system of claim 9, further comprising:
a device manager for managing at least one device within the facility according to surveillance data and climate data.

16. The system of claim 15, wherein the at least one managed device includes lighting systems, refrigeration units, climate control systems, elevators, escalators, and high-voltage integrated circuit (“HVIC”) units.

17. A computer readable storage medium including a set of instructions that are executable by a processor, the set of instructions being operable to:
monitor energy usage within a facility to generate energy usage data (“EUD”);
analyze the EUD to determine a short-term energy requirement (“STER”) and a long-term energy requirement (“LTER”) of the facility;
obtain energy market data (“EMD”) of energy, the EMD including energy rate fluctuation data; and
obtain a pre-determined amount of energy from a utility provider, the pre-determined amount being determined as a function of at least one of the STER, the LTER, and the EMD.

18. The computer readable storage medium of claim 19, wherein the set of instructions are further operable to:
store energy for the LTER in a storage system; and
provide energy to the facility from one of the storage system and the utility provider.

19. The computer readable storage medium of claim 19, wherein the monitoring energy usage includes receiving surveillance data from a monitoring system within the facility, the surveillance data includes at least one of audio surveillance data and video surveillance data, and the EUD is generated as a function of the surveillance data.

20. The computer readable storage medium of claim 19, wherein the monitoring energy usage includes receiving climate data from a climate observation system within the facility, and the EUD is generated as a function of the climate data.
